(19) United States
(12) Patent Application Publication
(10) Pub. No.: US 2015/0032657 A1
(43) Pub. Date: Jan. 29, 2015

(54) COMPUTERIZED SYSTEM FOR THE DISTRIBUTION OF A MULTI-PLATFORM DIGITAL PUBLISHING PRODUCT AND RELATIVE METHOD

(71) Applicant: SORRIDI EDITORE S.R.L., Milano (IT)

(72) Inventors: IVO EMANUELE FRANCESCO BONIOLO, Bovisio Masciago (MB) (IT); NICOLA GIUSEPPE TRAPLETTI, Grone (BG) (IT); YANEK STERZEL, Cassina de'Pecchi (MI) (IT)

(21) Appl. No.: 14/445,115

(22) Filed: Jul. 29, 2014

(30) Foreign Application Priority Data
Jul. 29, 2013 (IT) TV2013A000118

(51) Int. Cl. G06Q 10/08; H04L 29/08

(52) U.S. Cl. CPC G06Q 10/08; H04L 67/10
USPC 705/342

(57) ABSTRACT

The present invention relates to a computerized system for the distribution of a digital publishing product (200) realized by means of the Adobe InDesign™ publishing software platform.

The computerized system comprises a web-server (10), resident in a first computerized unit (1) operatively connectable to a digital communication network (90) to communicate with said at least one second computerized unit (2), which is capable of connecting with said first computerized unit by means of a web-browser (20), said web-server comprising a web-portal (10A) adapted to make available said digital publishing product;

The computerized system characterized by the fact it comprises:
one or more first software application modules (11) executable by said second computerized unit, said first software application modules interacting with said web-server for executing the identification of an user and to enable access the contents of said digital publishing product;
one or more second software application modules (12) executable by said second computerized unit, said second software application modules interacting with said web-server to collect browsing data indicating the modes by which an user interacts with a the contents
one or more third software application modules (13) executable by said second computerized unit, said third software application modules interacting with said web-server for enabling an user to write and/or read comments about the contents of said digital publishing product, while browsing through said digital publishing product;
one or more fourth software application modules (14) executable by said second computerized unit, said fourth software application modules interacting with said web-server for enabling an user to access auxiliary contents of said digital publishing product;
one or more fifth software application modules (15) executable by said first computerized unit; said fifth software application modules being configured for classifying and ordering according to predefined key words, the browsing data collected by said second application modules;
one or more sixth software application modules (18) executable by said first computerized unit said sixth software application modules being configured for generating a browsing profile of an user based on the browsing data ordered and classified by said fifth software application modules;
one or more seventh software application modules (19) executable by said second computerized unit, said seventh software application modules interacting with said web-server for enabling to display, in a predefined graphic format, information regarding the browsing profile of an user.

The present invention relates to a computerized system and a method for the distribution of a digital publishing product, in particular a multi-platform digital publishing product.

It is known how the term “digital publishing product” identifies a publishing product (for example a periodical, magazine or catalogue) whose informative contents are made available by means of digital communication systems (for example via Internet).

Numerous examples of computerized systems for the distribution of digital publishing products are known.

Many state-of-the-art computerized systems provide digital publishing products realized by means of publishing design software platforms that have been developed ‘ad hoc’.

This sometimes leads to problems of compatibility when it comes to viewing or displaying the contents of a digital publishing product and the related need to purchase costly software packages in order to be able to access the contents.

Often, the services made available to the user when viewing a digital publishing product are unsatisfactory and are limited to enabling consultation by means of different types of platforms, for example via tablet, smartphone or personal computer.

Some known computerized systems are able to provide services for analyzing the behavior of users while browsing through the contents of a digital publishing product.

Typically, however, the information collected by these computerized systems generally concerns users who have purchased or consulted the publishing product, without precise reference to specific users.

The main object of the present invention is to provide a computerized system and a method for the distribution of digital publishing products that can overcome the problems of the known art.

In the context of this object, an aim of the present invention is to provide a computerized system and a method that can offer easy access the contents of a digital publishing product by means of different types of computerized devices and/or by making use of different types of operating systems.

A further aim of the present invention is to provide a computerized system and a method that can enable an user to purchase a digital publishing product with a single payment operation, regardless of the type of operating system installed on the computerized device used to access the contents of the digital publishing product.

Yet another aim of the present invention is to provide a computerized system and a method that are able to offer the user easy access information correlated with the contents of a digital publishing product, during consultation of the product.

A further aim of the present invention is to provide a computerized system and a method that are able to provide services for analyzing the behavior of the user while browsing through the contents of a digital publishing product.

Yet another aim of the present invention is to provide a computerized system and a method for the distribution of digital publishing products that are of relatively simple practical implementation, at competitive costs.

This object and these aims, together with other aims that will become more apparent from the subsequent description and from the accompanying drawings, are achieved, according to the invention, by a computerized system for the distribution of a digital publishing product, according to claim 1 and the relative dependent claims.

The present invention also relates to a method for the distribution of a digital publishing product, according to claim 11 and the relative dependent claims.

Further characteristics and advantages of the present invention will become more apparent with reference to the description given below and to the accompanying figures, provided purely for explanatory and non-limiting purposes, wherein:

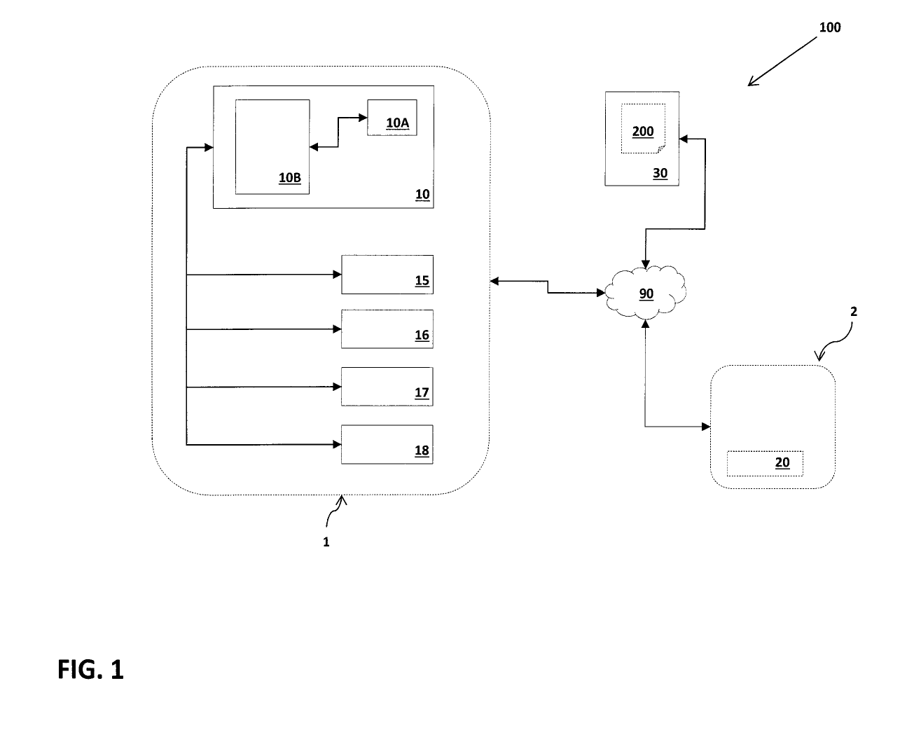

FIG. 1 shows a schematic view of the computerized system for the distribution of a digital publishing product, according to the invention; and

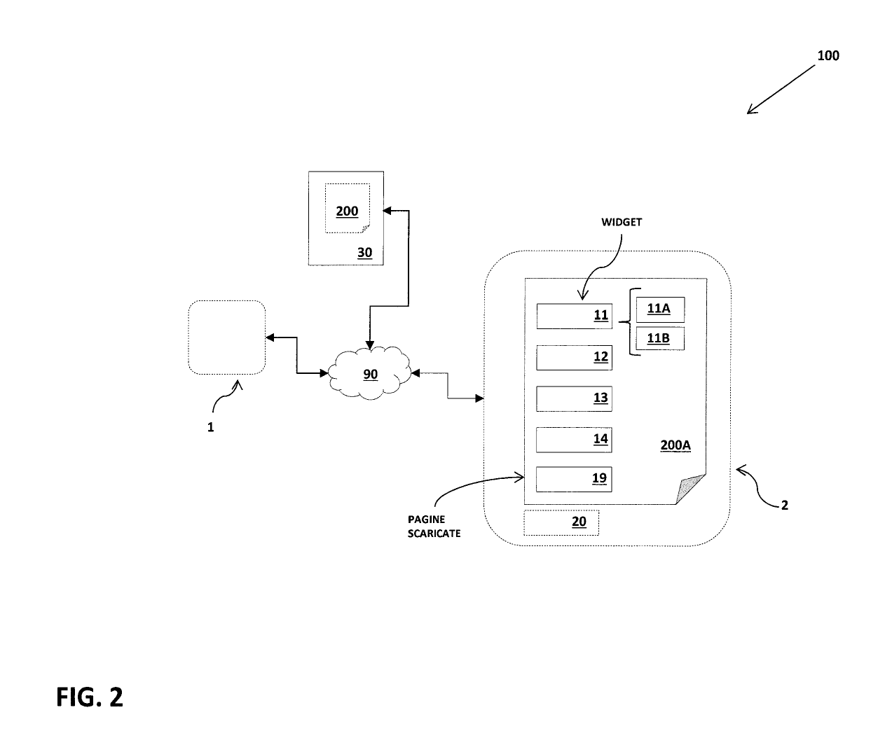

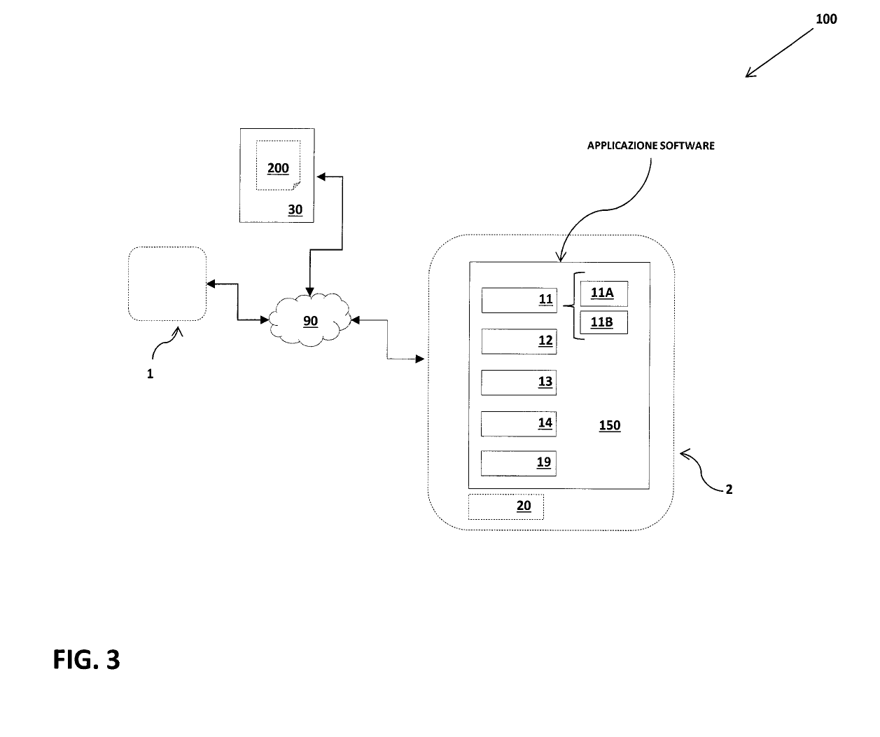

FIGS. 2-3 display schematic views of several variants of the computerized system for the distribution of a digital publishing product, according to the invention.

With reference to the above-mentioned figures, the present invention relates to a computerized system 100 for the distribution of a digital publishing product 200, for example a digital magazine, a digital book, a digital catalogue or similar.

The publishing product 200 is advantageously realized by means of the known Adobe InDesign™ publishing software platform,

In this way, the publishing product 200 is fully compatible with the most common operating systems on the market (for example the Android™ or Apple™ operating systems) and can be easily enhanced by adding strings of code executable in HTML5 format (scripts) in order to propose multimedia contents that integrate the contents of the publishing product.

The use of the Adobe InDesign™ software platform to realize the publishing product 200 also offers numerous advantages in terms of versatility and quality in the design of the publishing product.

For example, it is possible to obtain more stable digital publishing products, with production methods similar to those used for paper publishing products.

The computerized system 100 comprises a software resource platform specifically adapted to make available the publishing product 200.

As can be seen below, several software resources of the computerized system 100 can be stored and executed on computerized devices or other hardware resources not included in the computerized system itself.

The computerized system 100 may also comprise hardware resources specifically adapted to store and execute at least some of the above-mentioned software resources.

According to the invention, the computerized system 100 comprises a web-server 10 resident in a first computerized unit 1.

The web-server 10 is formed of one or more dedicated software applications, installed in the computerized unit 1, executable by one or more processing units (not illustrated) of the computerized unit 1.

The computerized unit 1 can be operatively connected to a digital communication network 90, for example the Internet or any LAN (Local Access Network) communication network.

The computerized unit 1 may consist of a single computerized device or of several computerized devices interacting with one another, for example to implement a “cloud” type processing architecture.

The computerized unit 1 is advantageously provided with an operating system for devices with “server” type functionality, for example Windows Server™, Windows Azure™, Mac OS Server™ or similar.

By means of the communication network 90, the computerized unit 1 is able to communicate with at least one second computerized unit 2 (“client” computerized unit), which is in turn capable of connecting (i.e. opening a channel of communication) with the computerized unit 1 by means of a web-browser 20, using a wired or wireless connection.

For further clarity, it is useful to point out that, in principle, the computerized unit 1, the communication network 90, and the computerized unit 2 are not necessarily part of the computerized system 100, according to the invention.

In some variants of the present invention, some hardware resources, such as the computerized unit 1, are developed in a proprietary manner and are comprised in the computerized system 100.

As will be better illustrated below, however, both the computerized unit 1 and the computerized unit 2 are adapted to store and/or run software resources that are part of the computerized system 100.

The computerized unit 2 may be any desktop computerized device, advantageously provided with an operating system for devices with “client” type functionality, for example a personal computer provided with the operating system Windows 8™, Mac OS™ or similar.

Alternatively, the computerized unit 2 may be any mobile computerized device, for example a smartphone, tablet, hand-held device, laptop or similar, advantageously provided with the operating system Android™, iOS™ or similar.

Advantageously, the computerized unit 2 is configured to be able to run software products distributed by Adobe™.

The web-server 10 is advantageously configured to manage data storage and processing in the computerized unit 1 and the communication and/or exchange of data between the web-server and the computerized unit 2, by means of the digital communication network 90.

The web-server 10 advantageously comprises a database 10B adapted to store data and/or hypertext data structures accessible by means of the web-browser from the computerized unit 2.

The web-server 10 also comprises a web-portal 10A adapted to make available the publishing product 200 through the communication network 90.

An user can access the web-portal 10A by means of normal Internet browsing using the computerized unit 2 and the relative web-browser.

The publishing product 200 can be stored in the web-server 10 (for example in the database 10B). In this case, in order to access the publishing product 200, the user can connect directly to the web-portal 10A using the computerized unit 2 and the relative web-browser.

Alternatively, as illustrated in the above-mentioned figures, the publishing product 200 can be stored in a remote server 30 (that can be connected using the communication network 90), which may be a hardware resource that is not part of the computerized system 100.

In this case, in order to access the publishing content 200, the user can connect to the remote server 30 using the computerized unit 2 and the relative web-browser.

Preferably, the computerized system 100 is configured so that, in order to browse freely through the contents of a publishing product 200, the user needs to register and purchase the publishing product.

Preferably, the web-server 10 is configured so as to be able to implement e-commerce functions and registration of users who wish to access a publishing product 200.

To that end, the web-server 10 is advantageously configured for acquiring and store user identification data, sent by the user by means of the computerized unit 2, and to manage the purchase of a publishing product 200 by means of connecting to known types of e-commerce platforms, such as Paypal™ or similar.

Preferably, the web-server 10 is configured so that, once a publishing product 200 has been purchased (or credit for consultation has been received in the case of a free catalogue), the user has full access \the contents of the product, whatever the type of computerized unit 2 used by the user, following purchase or credit.

The web-portal 10A advantageously comprises one or more registration and purchase pages, to which the user can connect (for example via Internet) to complete a registration procedure and purchase a digital publishing product 200.

According to the invention, the computerized system 100 comprises one or more first software application modules 11 executable by the computerized unit 2.

The application modules 11 are configured for interacting with the web-server 10 to recognize an user and enable access the contents of a digital publishing product 200, available from the computerized unit 1 or the remote server 30.

For clarity, in the context of the present invention, it is understood that a software application module, executable by the computerized unit 2, “interacts” with the web-server 10 to implement a certain function, when said application module cooperates (by means of specific data exchanges and/or commands) with the web-server 10 for execution of the software instructions necessary for implementation of said function.

The software instructions necessary for implementation of a certain function may be comprised in the application module itself and/or in the web-server 10, and may therefore be executed at the level of computerized unit 2 and/or at the level of computerized unit 1.

Preferably, the application modules 11 comprise one or more login application modules 11A configured to execute a login procedure for the web-portal 10A.

This login procedure advantageously comprises the following steps:
acquisition of user identification data (for example e-mail address and password);
sending user identification data to the web-server 10;
receiving authorization data from the web-server 10 indicating whether or not the user is authorized to browse through the contents of the publishing product 200, said authorization data being processed by the web-server 10 based on the user identification data;
storing the authorization data in the cache memory of the computerized unit 2;
making a further comparison with the user identification data;
definitively authorizing the user to browse through the contents of the publishing product 200, if the authorization data indicate that the user is authorized to browse;
redirecting (if permitted) the user to the registration and purchase pages of the web-portal 10A, if the authorization data indicate that the user is not authorized to browse.

Preferably, the application modules 11 comprise one or more checking application modules 11B configured for interacting with the login application modules 11A to check the identity of the user of the computerized unit 2, while browsing.

The checking application modules 11B are preferably configured so as to request from the login application modules 11A data indicating the user's authorization status, during browsing (for example when the user tries to access a new page).

The login application modules 11A are preferably configured for interacting with the web-portal 10A so as to acquire data indicating the user's authorization status, when they receive the request from the checking application modules 11B.

The checking application modules 11B are advantageously configured to authorize the user to continue browsing, in the case where the response data received from the login application modules 11A indicate that the user is authorized to browse.

The checking application modules 11B are advantageously configured to redirect the user to the registration and purchase pages of the web-portal 10A, in the case the response data received from the login application modules 11A indicate that the user is not authorized to browse.

Preferably, the application modules 11 (particularly the login modules 11A and checking modules 11B) are advantageously configured so as to enable the user to browse through some predefined contents of the publishing product 200 before executing the login procedure described above.

While browsing on the Internet or running a dedicated software application (for example the software application for a digital magazine) the user can access, by the computerized unit 2, the web-portal 10A or the remote server 30 through the communication network 90 and select the digital publishing product 200 to view (for example a specific edition of a digital magazine).

Advantageously, for the purposes of making easier the search, the relative web-previews of the contents of the publishing product 200 can be indexed and easily found by common search engines on the Internet.

The user can browse through some predefined contents of the publishing product 200 (for example the opening pages of the selected magazine issue) before being redirected to the registration and purchase pages of the web-portal 10A.

Once the user has been redirected, the login application modules 11A can advantageously execute the login procedure described above in conjunction with the web-server 10.

The solution described is particularly advantageous given the fact that it enables the user to make a more targeted choice of which digital publishing product to purchase.

In fact, the user can briefly consult the contents of the publishing product 200 (and as shown below any auxiliary content associated with it)

According to the invention, the computerized system 100 comprises one or more second software application modules 12 executable by the computerized unit 2.

The application modules 12 are configured for interacting with the web-server 10 to collect and store browsing data indicative of the interaction of an user with the contents of the publishing product 200, while browsing through the publishing product itself.

Said browsing data can comprise information regarding a “passive-type” interaction with the contents of the publishing product 200, for example information about contents displayed during browsing and/or about the frequency by which a certain contents has been selected.

Said browsing data can comprise information regarding an “active-type interaction” with contents of the publishing product 200, for example information regarding possible comments about a content of the publishing product 200, inserted by user directly in/from the publishing product itself or in/from a social network such as “Facebook” or “Twitter”.

Said browsing data can also comprise information inserted by the user during the above described login procedure.

Preferably, the application modules 12 are configured for executing an explicit collection of said browsing data, for example, by submitting to the user questionnaires for collecting information the user can fill while browsing, and/or for executing an implicit collection (in other words invisible to the user) of said data.

It is important to note that since said browsing data collection is the result of the interaction of software programs (the web-server 10 and the application module 12) executed at the level of the first and second computerized units 1, 2, respectively.

In comparison with what should be possible by the known tracking mechanism (for example by means of cookies), this approach enables to collect information also about active-type interactions having the contents of the publishing product 200, from an user.

For example, it is possible to collect information about possible comments regarding a contents of the publishing product 200, inserted by the user in a social network.

Preferably, the web-server 10 is configured for acquiring from the computerized unit 2, the browsing data collected and sent by the application modules 12 and storing such data in the databases 10B.

According to the invention, the computerized system 100 comprises one or more third software application modules 13 executable by the computerized unit 2.

The application modules 13 are configured for interacting with the web-server 10 to enable an user to write and/or read comments about the contents of the publishing product 200, while browsing through the publishing product.

Preferably, the application modules 13 are configured so as to make available spaces or windows in which the user, during browsing, can add comments relating to a certain content of the publishing product 200.

Preferably, the web-server 10 is configured for acquiring from the computerized unit 2 the comments added by the user (collected and sent by the software application modules 12) and stored in the database 10B.

Preferably, the web-server 10 is configured for executing functions relating to sorting and selecting stored comments based on pre-defined criteria (for example by rating).

Preferably, the web-server 10 is configured for publishing stored comments (added by the user and/or by third-party users) on other platforms operatively connected to the digital communication network 90 and selectable initially by the user, for example on a social network such as Facebook™ or Twitter™.

Preferably, the application modules 13 are configured for making available spaces or windows in which comments (added by the user or by other users) are published, relating to a certain content of the publishing product 200.

Preferably, the web-server 10 is configured to send the comments to be published to the computerized unit 2, selecting those comments based on the content of the publishing product 200 visited by the user (and therefore based on the data collected and sent to the web-server 10 by the software application modules 12).

Preferably, the application modules 13 are configured so as to make available spaces or windows in which the user can rate published comments.

Preferably, the web-server 10 is configured for acquiring from the computerized unit 2 the data relating to the rating expressed by the user and stored in the database 10B.

According to the invention, the computerized system 100 comprises one or more fourth software application modules 14 executable by the computerized unit 2.

The application modules 14 are configured for interacting with the web-server 10 to enable an user to access auxiliary contents of the publishing product 200.

Auxiliary contents may comprise, for example, information or multimedia contents of any type not originally included in the publishing product 200 but related or pertinent to the contents of the product.

Auxiliary contents are advantageously selectable from the web-server 10 and can be stored by it or by other servers that can be connected to it.

The display of these auxiliary contents may be advantageously activated by selecting several hypertext links made available on the pages of the publishing product 200.

According to a preferred embodiment of the present invention (FIG. 2), all or some of the application modules 11, 12, 13, 14 consist of software programs of the widget type, which are stored in the digital publishing product 200 and activable while browsing through the publishing product.

In this case, one or more application modules 11, 12, 13, 14 may advantageously consist of one or more portions of code (for example HTML5 code) that are part of the domain of the publishing product 200 and are inserted in the publishing product for executing the functions described above, connected to and in conjunction with the web-server 10.

The portions of code buried in a certain page of the publishing product 200A can be executed by the computerized unit 2 when that page is downloaded (from the web server 10 or from the server 30) and stored by the computerized unit 2 (for example in the cache memory), and the user visits or selects several corresponding predefined contents of that page.

For example, the software application modules 11, described above, may be inserted, in the form of a widget, in a certain page 200A of the publishing product 200 and be executed as soon as that page is downloaded from the web-server 10 and visited by the user.

The application modules 11 can thus be easily configured to enable the user to freely visit a preview of the pages prior to page 200A and \ the login procedure, described above, as soon as the above-mentioned page is reached, while browsing through the contents of the publishing product 200.

Preferably, the application modules 13 and 14 consist of corresponding software programs of the widget type stored in one or more auxiliary pages (also called “extra-content pages”) included in the publishing product 200.

These auxiliary pages are in addition to the original contents of the publishing product 200 and are initially inactive.

Preferably, the application modules 13 and 14 can be selectively activated by the user by moving the computerized unit 2 or by sending a pre-defined command to the computerized unit 2.

In the case where the computerized unit 2 consists of a mobile computerized device, the application modules 13 and 14 may be activated by the user by moving the computerized unit 2 according to one or more pre-defined movements, for example by rotating the display of the computerized unit 2.

In the case where the computerized unit 2 consists of a desktop computerized device, the application modules and 14 may be activated by selecting a command to rotate the image displayed on the screen (for example by selecting a specific icon on the screen with the mouse).

According to another embodiment of the present invention, one or more of the application modules 11, 12, 13, 14 (consisting of software programs) may be comprised in a dedicated software application 150 storable and executable by the computerized unit 2 (FIG. 3).

The application 150 may be advantageously downloaded from the web-server 10 should the user be interested in accessing the publishing product 200.

Obviously, variants of the present invention are possible according to which some software application modules consist of widgets that are resident in the publishing product 200, and other software application modules are contained in a dedicated software application 150.

One of the characteristics of the computerized system 100 is that it comprises software resources enabling to considerably expand the interactivity of the users with the publishing product 200 contents.

According to a preferred embodiment, the computerized system 100 comprises one or more fifth software application modules 15 that executable by the computerized unit 1.

Preferably, the application modules 15 are installed in the computerized unit 1.

The application modules 15 are used to analyze the data collected while browsing through the digital publishing product 200.

Particularly, the software application modules 15 are configured for acquiring the browsing data stored in the database 10B (by the application modules 12) and classifying and ordering, according to predefined key words (tags), said browsing data.

Preferably, the software application modules send the ordered and classified browsing data to the web-server 10 which store them in the database 10B.

The computerized system 100 comprises one or more sixth software application modules 18 executable by the computerized unit 1.

Preferably, the application modules 18 are installed in the computerized unit 1.

The application modules 18 are configured for generating a browsing profile of an user based on the browsing data ordered and classified by the application modules 15.

Advantageously, the browsing profile of an user is a set of data indicating the interaction level of an user with one or more publishing product 200 contents.

Advantageously, the browsing profile of an user comprises first data indicating the passive-type interaction level with the publishing product 200 contents.

Such data comprises one or more key words which are inserted in the browsing profile of an user by the application modules 18 based on the information classified and ordered by the application modules 18, for example, based on the contents visited by the user and/or based on the number of read comments regarding said contents.

If by analyzing the browsing data by the application modules 15, results that an user often passively interacted (he/she read articles and/or comments, performed searches, etc.) with determined contents of the publishing product 200, the application modules 18 generate a browsing profile comprising key words (tags) identifying said contents.

For example, if it results that an user, browsing through the publishing product 200, frequently reads articles or comments regarding station wagon type cars sold by German companies, the application modules 18 can generate a browsing profile comprising the predefined key words: CARS; STATION WAGON; GERMAN identifying the contents which the user has frequently interacted with.

In this case, the tags CARS; STATION WAGON; GERMAN form said first data indicating the main passive-type interaction activities with the contents of the publishing product 200.

The browsing profile of an user advantageously comprises second data indicating the level of active-type interaction with the contents of the publishing product 200.

Such data comprises one or more identifying indexes which are inserted in the browsing profile of an user by the application modules 18, based on the information classified and ordered by the application modules 15, for example, based on the number of comments inserted and based on the satisfaction expressed by other users.

For example, said second data can comprise a ranking expressing the estimated competence level achieved by the user with reference to publishing product 200 contents.

According to the invention, the computerized system 100 comprises one or more seventh software application modules 19 executable by the computerized unit 2.

Advantageously, the application modules 19 interact with the web-server 10 to enable the user to consult, in a pre-defined graphic format, data processed by the application modules 18.

Particularly, the application modules 18 interact with the web-server 10 for showing, in a pre-defined graphic format, information regarding the browsing profile of an user while browsing through the digital publishing product 200.

For example, the application modules 19 can enable to display, in real time, during browsing, a graphic indicating the trend of the level of competence reached by an user with reference to certain contents of the publishing product 200.

The application modules 19 may also be formed of corresponding software programs of the widget type, which are stored in the digital publishing product 200 and can be activated by the computerized unit 2 while browsing through the publishing product.

Alternatively, they may be software programs included in the software application 150, described above.

The application modules 15, 18, 19 offer several technical advantages.

On the one hand, such application modules enable to coherently and uniformly structure the browsing data of each user, collected by the application modules 12.

This enables to form a database which can be used for expanding the offer of publishing contents for the users.

On the other hand, said application modules enable to increase the interaction level of the users with the publishing product 200.

This enables to dynamically expand the contents of the publishing product 200 thanks to the active contribution of the users themselves.

For example, an user, who reached a relatively high competence ranking can in this way be acknowledged as an “opinion leader” with reference to certain contents of the publishing product 200, into something akin to a “competition” with the author (a journalist, for example) of such contents.

In this way, an user is encouraged to enhance his/her competence ranking by inserting in-depth comments about the contents of the publishing product 200 and/or by examining auxiliary available contents.

Preferably, the computerized system 100 comprises one or more eighth software application modules 16 executable by the computerized unit 1.

Preferably, the application modules 16 are installed in the computerized unit 1 and are executed for performing functionalities indexing the contents of the publishing product 200 by predefined search engines.

Preferably, the application modules 16 are configured for executing the indexing of the contents of the publishing product 200 based on key words (Tags) inserted in the publishing product 200 during the step of implementing the same.

The Indexing of the contents of the publishing product 200 on search engines, such as Google™ or Bing™, enables to substantially expand the dissemination of the contents of the publishing product 200, so that the possibility of accessing the contents themselves is considerably increased.

When conducting a search on the Internet, an user can obtain as a result a content (for example a preview of a page) of the publishing product 200.

By selecting this result, the user can connect to the web-portal 10A or the remote server 30 and see a preview of some pages of the publishing product 200.

The user may then decide to purchase the publishing product 200 containing the contents of interest, be redirected to the registration and purchase pages of the web-portal 10A before being once again redirected to the publishing product 200.

Preferably, the computerized system 100 comprises one or more ninth software application modules 17 executable by the computerized unit 1.

Preferably, the application modules 17 are installed in the computerized unit 1 and are executed to create dynamic indexes related to the contents of the publishing product 200, while browsing through the publishing product.

Preferably, the application modules 17 are configured to create the above-mentioned dynamic indices based on key words (Tags) inserted in the publishing product 200 when it is being created.

The creation of dynamic indices related to the contents of the publishing product 200 makes it possible to notably increase the quantity of information which the user has access during browsing, even when this browsing is in preview form before purchasing the publishing product itself.

When viewing a certain content of the publishing product 200, the application modules 17 are able to make available a series of links to contents related to the content visited. These related contents may be contained in publishing products other than that consulted at that moment.

The user can then access related contents of most interest by selecting the relative link and then possibly purchasing and/or browsing further publishing products (in the manner described above).

In a further aspect, the present invention also refers to a method for the distribution of a digital publishing product 200.

The method according to the invention comprises the following steps:
realizing the digital publishing product 200 by means of the Adobe InDesign™ publishing software platform,
providing the web-server 10, resident in the computerized unit 1, operatively connectable to the digital communication network 90 to communicate with at least the second computerized unit 2, which is capable of connecting with the computerized unit 1 by means of a web-browser 20, said web-server comprising a web-portal 10A adapted to make available the publishing product 200;
providing one or more first software application modules 11 executable by the computerized unit 2. The software application modules 11 interact with the web-server 10 for identifying an user and to enable access the contents of the digital publishing product 200;
providing one or more second software application modules 12 executable by the computerized unit 2. The application modules 12 interact with the web-server 10 to collect and store browsing data indicating the interaction mode of an user with the contents of said publishing product, said browsing data being stored in said database;
providing one or more third software application modules 13 executable by the computerized unit 2. The application modules 13 interact with the web-server 10 to enable an user to write and/or read comments about the contents of the publishing product 200, while browsing through said publishing product;
providing one or more fourth software application modules 14 executable by the computerized unit 2. The application modules 14 interact with the web-server 10 to enable an user to access auxiliary contents of the publishing product 200, for example by moving the computerized unit 2 according to one or more pre-defined movements or by selecting a command button;
providing one or more fifth software application modules 15 executable by the computerized unit 1. The application modules 15 are configured for acquiring the browsing data stored in the database 10B and classifying and ordering, according to predefined key words, the above mentioned browsing data;
providing one or more sixth software application modules 18 executable by the computerized unit 1. The application modules 18 are configured for generating a browsing profile of an user based on browsing data ordered and classified by the application modules 15.
providing one or more seventh software application modules 19 executable by the computerized unit 2. The application modules 19 interact with the web-server 10 for enabling to display in a predefined graphic format, information regarding the user profile during browsing through the publishing product 200.

Preferably, one or more of said application modules 11, 12, 13, 14, 19 are software programs of the “widget” type, which are stored in the publishing product 200 and can be activated by the computerized unit 2 while browsing through the contents of the publishing product 200.

Preferably, the application modules 13 and 14 are formed by corresponding software programs of the widget type, which are stored in one or more auxiliary pages of said digital publishing product.

Preferably, the application modules 13 and 14 can be activated by moving the computerized unit 2 or by sending a pre-defined command to the computerized unit 2.

Preferably, the method comprises the step of providing the software application 150, which can be stored and executed by the computerized unit 2. The software application 150 comprises one or more of the application modules 11, 12, 13, 14, 19.

Preferably, the method according to the invention comprises the step of providing one or more eighth software application modules 16 executable by the computerized unit 1 to implement functions indexing the contents of the publishing product 200 on search engines.

Preferably, the method according to the invention comprises the step of providing one or more ninth software application modules 17 executable by the computerized unit 1 for creating dynamic indexes regarding the contents of the publishing product 200 while browsing through the publishing product 200 itself.

It has been noted in practice how the present invention offers numerous advantages with respect to known computerized systems and methods.

The computerized system and the method, according to the invention, offer quick and easy access a digital publishing product by means of computerized devices, even if they are provided with different operating systems.

The computerized system and the method, according to the invention, enable an user to see a preview of the contents of a digital publishing product, before purchasing the product.

The computerized system and the method, according to the invention, enable an user to purchase the digital publishing product with a single payment operation, regardless of the type of operating system installed on the computerized unit used to consult the digital publishing product.

In this way, the user can avoid having to repeatedly purchase the same digital publishing product from the “store” corresponding to the operating system installed (for example the Apple Store™ for an Apple™ operating system, the Play Store™ for an Android™ operating system, and so on).

The computerized system and the method, according to the invention, make it possible to easily collect information about the activity and preferences of an user while browsing through a digital publishing product.

The computerized system and the method, according to the invention, enable an user to interact easily with the contents of a digital publishing product, in particular to write and/or read comments about the contents visited, directly while browsing through the publishing product.

The computerized system and the method, according to the invention, enable easy and immediate sharing with other users of the comments published about the contents of a digital publishing product.

The computerized system and the method, according to the invention, make it possible to implement functions indexing the contents of a digital publishing product on search engines, thereby increasing the number of users potentially interested in the digital publishing product.

The computerized system and the method, according to the invention, make it possible to implement indexing functions on information related to the contents of a digital publishing product, thereby providing the user with a large selection of information for consultation.

The computerized system and the method, according to the invention, are of relatively simple practical implementation, at competitive costs.

1. Computerized system for the distribution of a digital publishing product (200), said digital publishing product being realized by means of the Adobe InDesign™ publishing software platform, said computerized system comprising:
a web-server, resident in a first computerized unit operatively connectable to a digital communication network for communicating with at least one second computerized unit capable of connecting with said first computerized unit by means of a web-browser, said web-server comprising a web-portal and a database;
characterized by the fact it comprises:
one or more first software application modules executable by said second computerized unit, said first software application modules interacting with said web-server for executing the identification of an user and enabling the access to the contents of said digital publishing product;
one or more second software application modules executable by said second computerized unit, said second software application modules interacting with said web-server to collect browsing data indicating the modes by which an user interacts with the contents of said publishing product, said browsing data being stored in said database;
one or more third software application modules (13) executable by said second computerized unit, said third software application modules interacting with said web-server for enabling an user to write and/or read comments while browsing through said digital publishing product;
one or more fourth software application modules executable by said second computerized unit, said fourth software application modules interacting with said web-server for enabling an user to access auxiliary contents regarding said digital publishing product;
one or more fifth software application modules executable by said first computerized unit; said fifth software application modules being configured for classifying and ordering, according to predefined key words, the browsing data collected by said second application modules;
one or more sixth software application modules executable by said first computerized unit; said sixth software application modules being configured for generating a browsing profile of an user based on the browsing data ordered and classified by said fifth software application modules;
one or more seventh software application modules executable by said second computerized unit; said seventh software application modules interacting with said web-server for enabling to display, in a predefined graphic form, information regarding the browsing profile of an user.

2. Computerized system, according to claim 1, characterized in that said one or more of said first software application modules, second software application modules, third software application modules, fourth and seventh software application modules are formed by corresponding software programs of the widget type stored in said digital publishing product and activable while browsing through said digital publishing product.

3. Computerized system, according to claim 2, characterized in that said third software application modules and said fourth software modules are formed by corresponding software programs of the widget type, stored in one or more auxiliary pages of said digital publishing product.

4. Computerized system, according to claim 3, characterized in that said third software application modules and said fourth software application modules are activable by moving said second computerized unit or by sending a predefined command to said second computerized unit.

5. Computerized system, according to claim 1, characterized in that it comprises a software application storable and executable by said second computerized unit, said software application comprising one or more of said first, second, third, fourth and seventh software application modules.

6. Computerized system, according to claim 1, characterized in that it comprises one or more eighth software application modules executable by said first computerized unit for indexing on search engines the contents of said digital publishing product.

7. Computerized system, according to claim 1, characterized in that it comprises one or more ninth software application modules executable by said first computerized unit for creating dynamic indexes regarding the contents of said digital publishing product while browsing through said digital publishing product.

8. Method for distributing a digital publishing product comprising the following steps:
realizing said digital publishing product by means of an Adobe InDesign™ publishing software platform,
providing a web-server resident in a first computerized unit operatively connectable to a digital communication network for communicating with at least a second computerized unit, which is capable of connecting with said first computerized unit by means of a web-browser, said web-server comprising a web-portal and a database;
characterized by the fact it comprises the following steps:
providing one or more first software application modules executable by said second computerized unit, said first software application modules interacting with said web-server for executing the identification of an user and to enable the access to the contents of said digital publishing product;
providing one or more second software application modules executable by said second computerized unit, said second software application modules interacting with said web-server to collect browsing data indicating the modes by which an user interact with the contents of said publishing product, said browsing data being stored in said database;
providing one or more third software application modules executable by said second computerized unit, said third software application modules interacting with said web-server for enabling an user to write and/or read comments while browsing through said digital publishing product;
providing one or more fourth software application modules executable by said second computerized unit, said fourth software application modules interacting with said web-server for enabling an user to access auxiliary contents regarding said digital publishing product;
providing one or more fifth software application modules executable by said first computerized unit; said fifth software application modules being configured for classifying and ordering, according to predefined key words, the browsing data collected by said second application modules;
providing one or more sixth software application modules executable by said first computerized unit, said sixth software application modules being configured for generating a browsing profile of an user based on the browsing data ordered and classified by said fifth software application modules;
providing one or more seventh software application modules executable by said second computerized unit; said seventh software application modules interacting with said web-server for enabling to display, in a predefined graphic format, information regarding the browsing profile of an user.

9. Method, according to claim 8, characterized in that one or more of said first software application modules, second software application modules, third software application modules, fourth software application modules and seventh software application modules are software programs of the widget type stored in said digital publishing product and activable while browsing through said digital publishing product.

10. Method, according to claim 9, characterized in that said third software application modules and said fourth software modules are formed by corresponding software programs of the widget type, stored in one or more auxiliary pages of said digital publishing product.

11. Method, according to claim 10, characterized in that said third software application modules and said fourth software modules are activable by moving said second computerized unit or by sending a command to said second computerized unit.

12. Method, according to claim 8, characterized in that it comprises the step of providing a software application storable and executable by said second computerized unit, said software application comprising one or more of said first, second, third, fourth and seventh software application modules.

13. Method, according to claim 8, characterized in that it comprises the step of providing one or more eighth software application modules executable by said first computerized unit for indexing on search engines the contents of said publishing product.

14. Method, according to claim 8, characterized in that it comprises the step of providing one or more ninth software application modules executable by said first computerized unit for creating dynamic indexes regarding the contents of said publishing product while browsing through said publishing product.
